(19) United States
(12) Patent Application Publication
(10) Pub. No.: US 2019/0361597 A1
(43) Pub. Date: Nov. 28, 2019

(54) SYSTEM, METHOD AND COMPUTER-ACCESSIBLE MEDIUM FOR FACILITATING THE SELECTION OF AN OBJECT

(71) Applicant: Virtual Diamond Boutique Inc.,, New York, NY (US)

(72) Inventor: Jonathan EVANS, San Francisco, CA (US)

(21) Appl. No.: 16/480,576

(22) PCT Filed: Jan. 23, 2018
(86) PCT No.: PCT/US18/14929

§ 371 Date: Jul. 24, 2019

Related U.S. Application Data
(60) Provisional application No. 62/449,664, filed on Jan. 24, 2017.

(51) Int. Cl. G06F 3/0484; G06Q 30/06; G06F 3/0482

(52) U.S. Cl. CPC G06F 3/04847; G06F 3/0482; G06Q 30/0643; G06Q 30/0621

(57) ABSTRACT

An exemplary system, method and computer-accessible medium for facilitating a selection of an object(s) can be provided, which can, for example and/or using computer processing configuration(s), provide, to a user(s) over a network, a digital representations of the object(s) and a plurality of attributes pertaining to the object(s), receive, from the user(s) over the network, a selection of a particular attribute of the attributes to be viewed by the user(s) and a parameter(s) related to the attribute, modify the object(s) based on the parameter(s), and transmit, over the network to the user(s), the modified object(s).

### CROSS-REFERENCE TO RELATED APPLICATION(S)

This application relates to and claims priority from U.S. Patent Application No. 62/449,664, filed on Jan. 24, 2017, the entire disclosure of which is incorporated herein by reference.

### FIELD OF THE DISCLOSURE

The present disclosure relates generally to digital object selection, and more specifically, to exemplary embodiments of exemplary system, method and computer-accessible medium for facilitating the selection of at least one digital object.

### BACKGROUND INFORMATION

As the Internet and e-commerce have expanded, the number of users searching for and purchasing things on the internet has expanded as well. However, many websites and interfaces make it difficult to search for, and select, an object (e.g., a digitally represented object) to buy. For example, if an object has many attributes, it can be difficult for a user to select and narrow down the particular attributes in order to facilitate selecting and buying the object.

Thus, it may be beneficial to provide an exemplary system, method and computer-accessible medium for facilitating the selection of an object, which can overcome at least some of the deficiencies described herein above.

### SUMMARY OF EXEMPLARY EMBODIMENTS

An exemplary system, method and computer-accessible medium for facilitating a selection of an object(s) can be provided, which can include, for example, providing, to a user(s) over a network, a digital representations of the object(s) and a plurality of attributes pertaining to the object(s), receiving, from the user(s) over the network, a selection of a particular attribute of the attributes to be viewed by the user(s) and a parameter(s) related to the attribute, modifying the object(s) based on the parameter(s), and transmitting, over the network to the user(s), the modified object(s).

In certain exemplary embodiments of the present disclosure, the object(s) can be a gemstone(s). The attribute(s) can include (i) a color of the gemstone(s), (ii) a clarity of the gemstone(s), (iii) a cut of the gemstone(s), (iv) a polish of the gemstone(s) or (v) a depth percent of the gemstone(s). The attribute(s) can also include (i) a budget, (ii) a certifying body, (iii) a shape of the gemstone(s), (iv) a size of the gemstone(s), (v) a symmetry of the gemstone(s) or (vi) a table percent of the gemstone(s). The at least one gemstone can include a diamond. The selection of the particular attribute and the parameter(s) related to the attribute can be received from a mobile device. The object and the attribute(s) can be stored in a database(s). In some exemplary embodiments of the present disclosure, the database(s) can be queried based on the selection of the particular attribute and the parameter(s) related to the attribute.

In some exemplary embodiments of the present disclosure, a further selection of a further particular attribute of the attributes to be viewed by the user(s) and a further parameter(s) related to the further attribute can be received over a network (e.g., by a computer processor arrangement), and the object(s) can be modified based on one further parameter. The selection can be based on a rotation of a digital wheel by the user(s). The selection of the particular attribute(s) and the parameter related to the attribute(s) can be received from a web-based application. The parameter can be modified based input from the user(s) (e.g., by the computer processor arrangement), which can be performed using a digital slider(s). The parameter can be modified (e.g., by the computer processor arrangement) based on an upper limit of the parameter and a lower limit of the parameter

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1 is an exemplary schematic diagram of an exemplary application server according to an exemplary embodiment of the present disclosure;

FIGS. 2-11B are exemplary images of the interface of the exemplary system, method and computer-accessible medium according to an exemplary embodiment of the present disclosure;

FIGS. 12 and 13 are exemplary schematic diagrams of an exemplary inventory search database according to an exemplary embodiment of the present disclosure;

FIG. 14 is an exemplary schematic diagram of an exemplary rails application server according to an exemplary embodiment of the present disclosure;

FIG. 15 is an exemplary flow diagram of an exemplary method for facilitating a selection of at least one object according to an exemplary embodiment of the present disclosure; and

FIG. 16 is an illustration of an exemplary block diagram of an exemplary system in accordance with certain exemplary embodiments of the present disclosure.

Throughout the drawings, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments and is not limited by the particular embodiments illustrated in the figures and the appended claims.

### DETAILED DESCRIPTION OF EXEMPLARY EMBODIMENTS

The exemplary embodiments of the present disclosure may be further understood with reference to the following description and the related appended drawings. The exemplary embodiments of the present disclosure relate to a system, method and computer-accessible medium for facilitating a selection of an object. The exemplary system, method and computer-accessible medium will described herein below with reference to jewelry and gemstones, however, the exemplary system, method and computer-accessible medium can be applied to other object selection (e.g., the selection of objects other than gemstones). Exemplary gemstones can include, but are not limited to, diamond, jade, amethyst, azurite, bismuth, onyx, opal, sapphire, topaz, quartz, emerald, garnet, obsidian, ruby, spinel, tanzanite, turquoise and zircon.

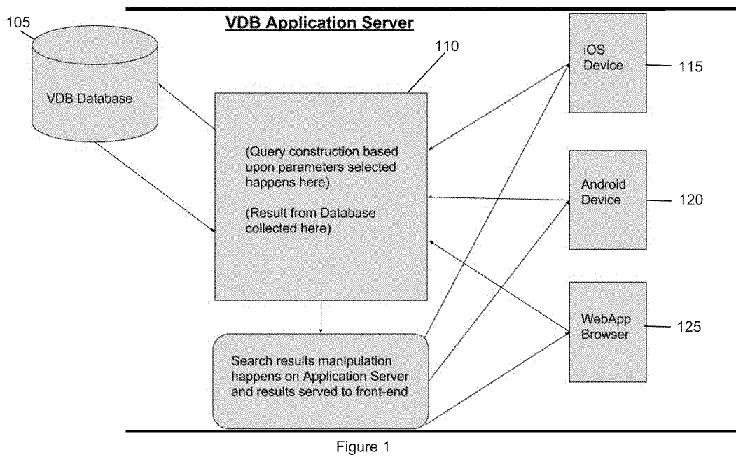

FIG. 1 shows an exemplary schematic diagram of an exemplary application server according to an exemplary embodiment of the present disclosure. For example, as shown therein, a VDB database 105 can contain information pertaining to a plurality of objects (e.g., gemstones). VDB database 105 can be queried by a server (e.g., application server 110), which can communicate with one or more devices (e.g., iOS device 115, Android device 120 or a web portal or Web App 125), which can facilitate a user to interact with application server 110 to select a gemstone (e.g., a gemstone from VDB database 105).

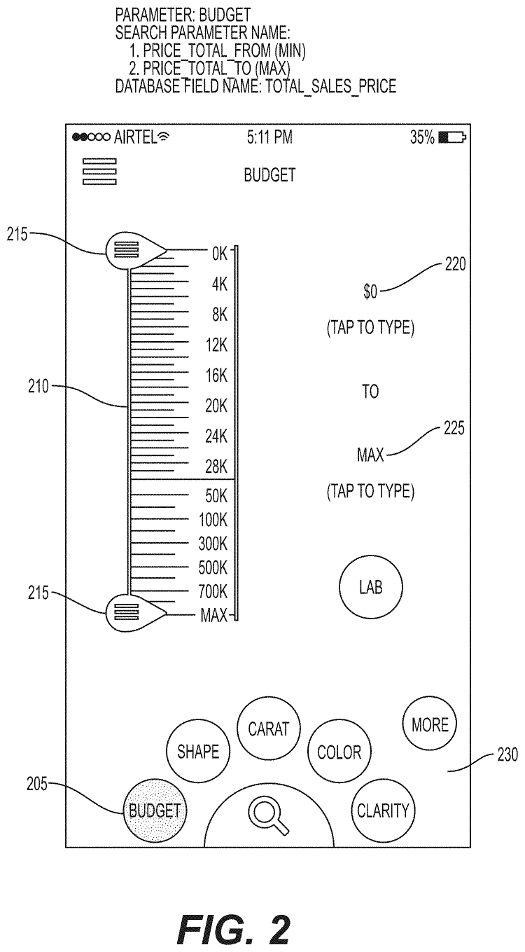

FIGS. 2-9C show exemplary images of the interface of the exemplary system, method and computer-accessible medium according to an exemplary embodiment of the present disclosure. For example, interface area 230 facilitates a user to select a particular attribute pertaining to the gemstone (e.g., attribute 205). Other exemplary attributes can include, but are not limited to shape, carat, color and clarity. In order to select one of the attributes, the user can tap one of the icons with the labelled attribute. Alternatively, or in addition, a user can slide their finger in a circular fashion around the attributes, which can change the highlighted (e.g., selected) attribute, or it can rotate further attributes into view.

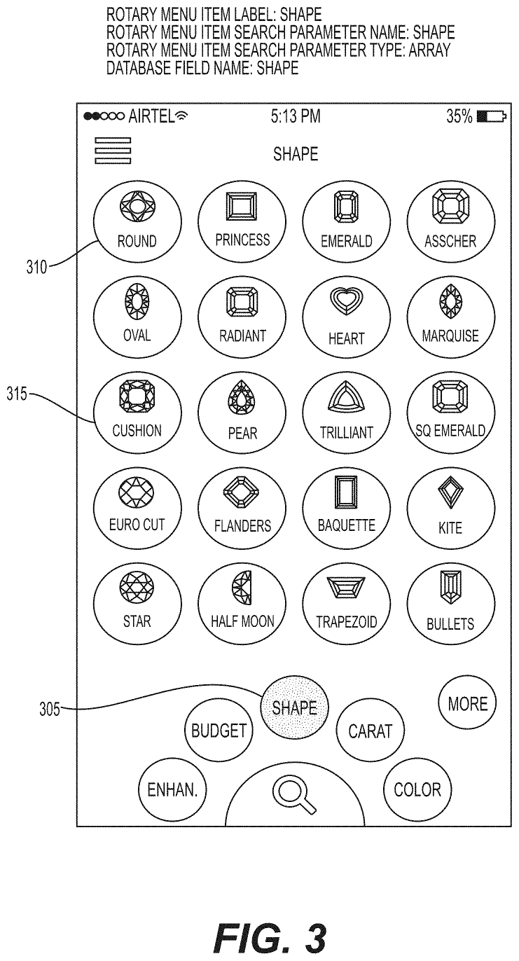

In particular, FIG. 2 shows the budget attribute being selected for a gemstone. For example, a user can select their desired budget from the budget bar 210. Budget bar 210 can have two slider 215 (e.g., an upper and a lower slider), which can adjust a range for the budget. Alternatively, or in addition, a user can tap area 220 and manually enter in a minimum budget and tap area 225 to manually enter in a maximum budget. After the user selects a budget, the user can select a different attribute (e.g., shape 305 as shown in FIG. 3). It should be noted that the user does not have to select an attribute in a particular order, and any attribute can be selected before or after any other attribute. Further, the user can skip the selection of one or more attributes.

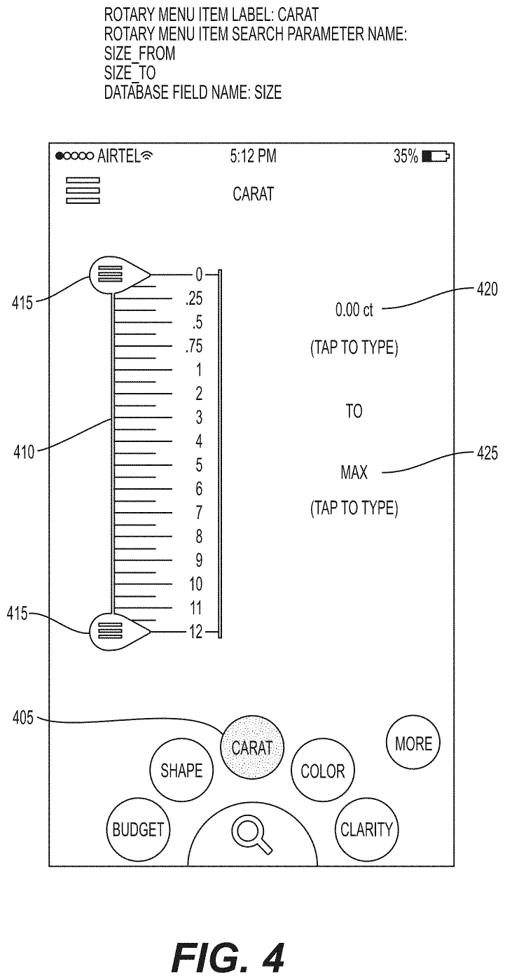

As shown in FIG. 3, once a user selects or slides to shape 305, the user can select from a variety of gemstone shapes (e.g., round shape 310 or cushion shape 315). After the user selects the desired shape, the user can select carat attribute 405, in order to select the desired carat. (See, e.g. FIG. 4). FIG. 4 shows an image of the carat attribute selection screen, which can be similar to the budget selection screen. For example, the user can select a range in carat bar 410 using sliders 415 (e.g., an upper and lower slider). Alternatively, or in addition, the user can manually enter the minimum carat (e.g., in area 420) and/or the maximum carat (e.g., in area 425).

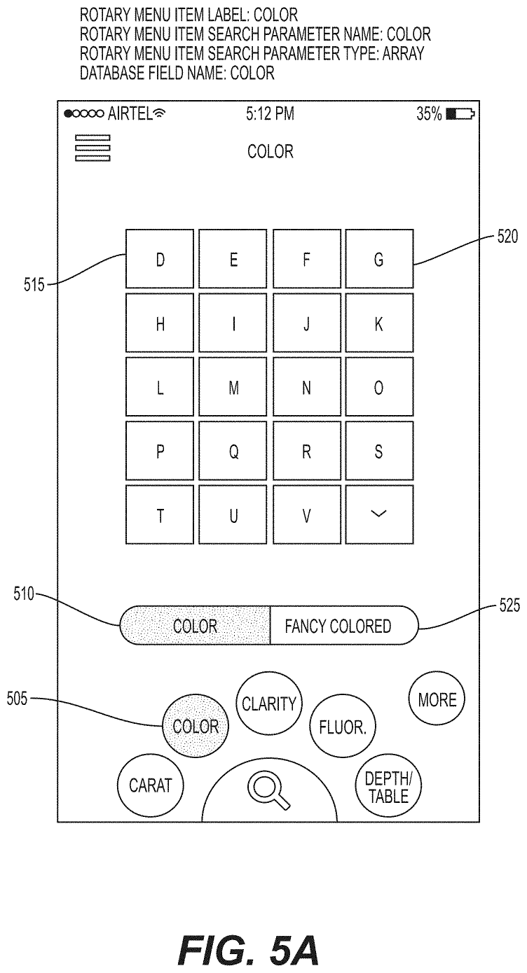

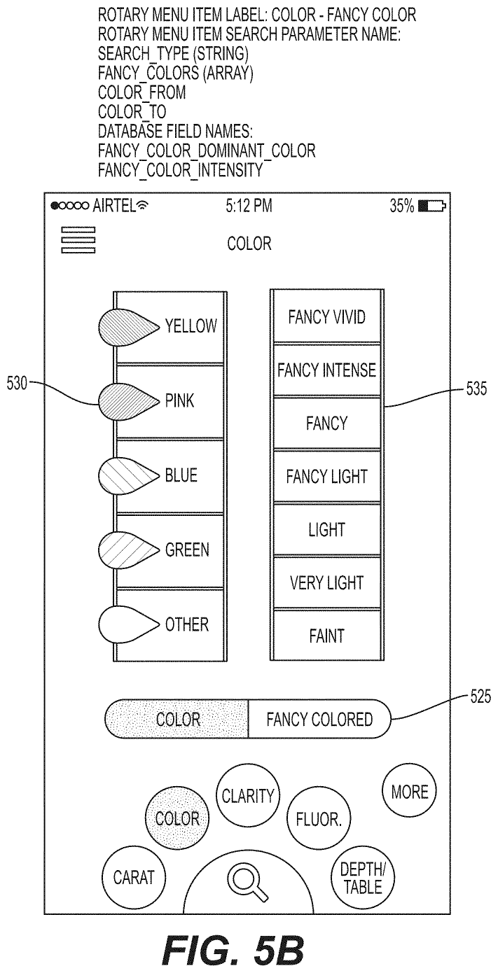

After the user selects the desired carat, the user can select color attribute 505, in order to select the desired color. For example, the user can choose from a standard color 510 (see, e.g., FIG. 5A), or from a fancy color 525 (see, e.g., FIG. 5B). Standard colors can include D color 515 and G color 520, and generally can include a range from D to V. As shown in the image in FIG. 5B, fancy color 525 can include a variety of fancy colors 530 (e.g., yellow, pink, blue, green and other). Various other color attributes can be selected in area 535.

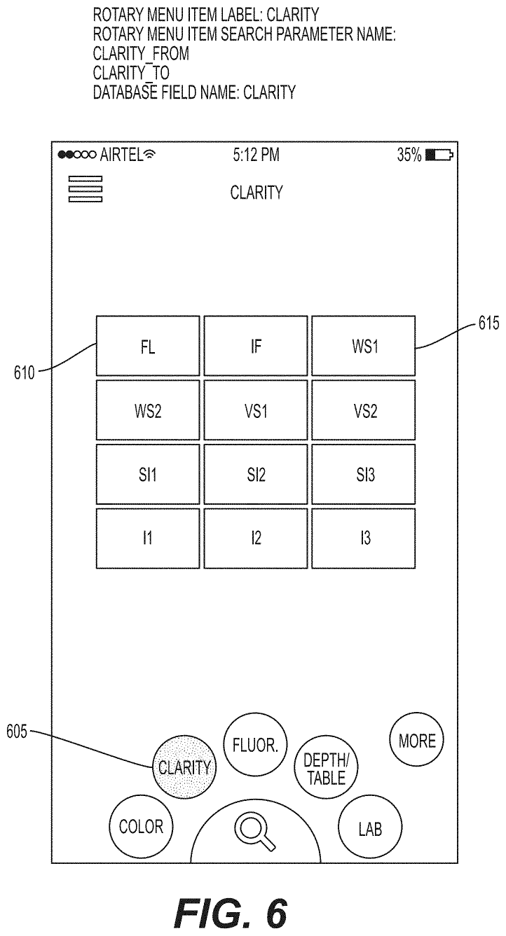

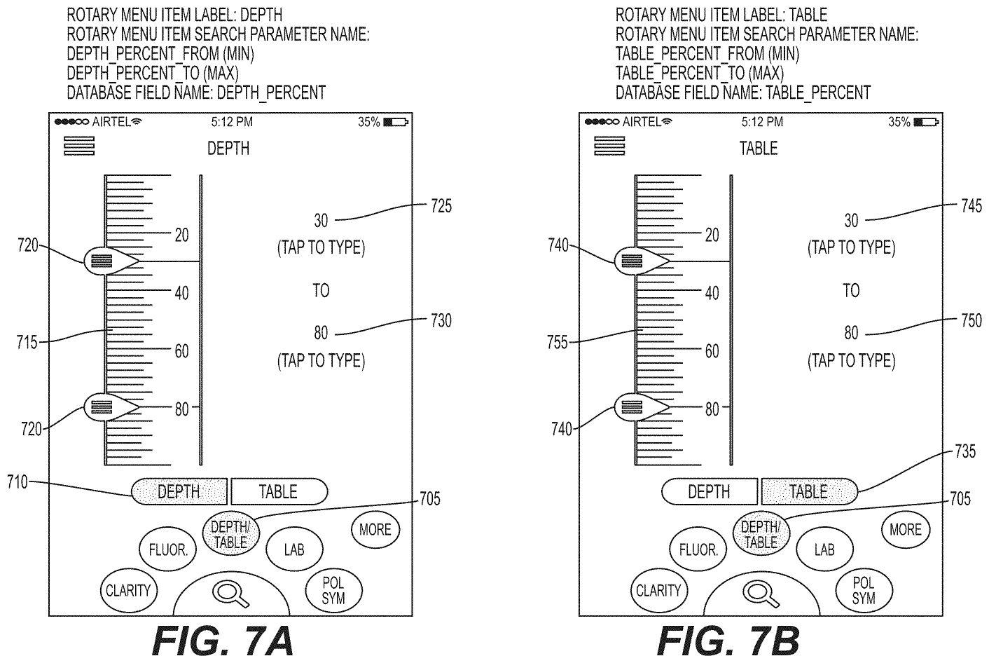

After the selection of the color, the user can select the clarity attribute 605, which can include various clarities 610 (e.g., flawless, internally flawless, very slightly included 1, very slightly included 2, very slightly included 1, very slightly included 2, slightly included 1, slightly included 2, slightly included 3, included 1, included 2 and included 3). (See, e.g., FIG. 6). The user can then select the depth/table attribute 705 (see, e.g., FIGS. 7A and 7B), which can include the selection of a depth 710 or a table 735. The depth and table screens can be similar to the budget screen. For example the depth screen 710 can include a depth bar 715, which can be controlled by sliders 720, and table screen 735 can include a table bar 755, which can be controlled by sliders 740. Depth screen 710 can also facilitate the manual input of the minimum depth (e.g., area 725) and maximum depth (e.g., area 730). Further, table screen 735 can facilitate the manual input of the minimum table (e.g., area 745) and maximum table (e.g., area 750).

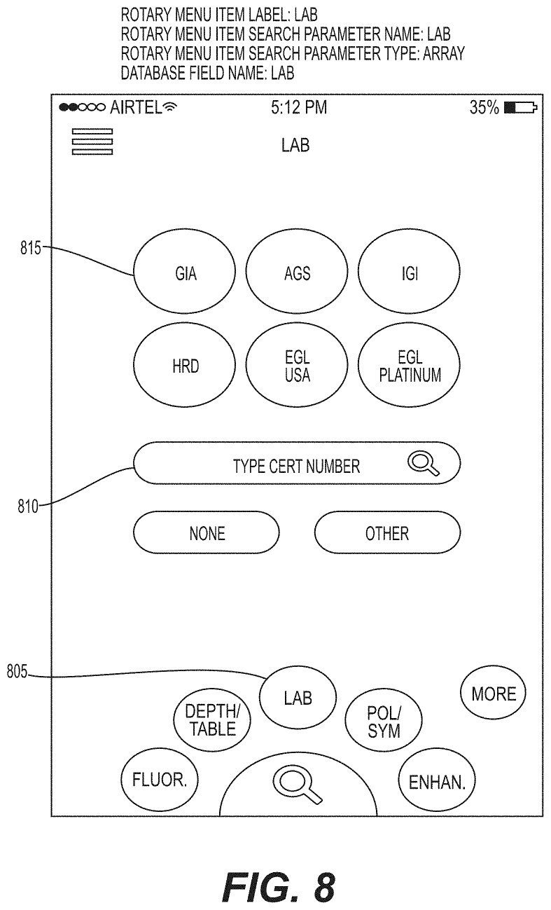

When the user selects the depth/table, the user can then select Lab attribute 805, which can facilitate the selection of a certification or certifying body. (See, e.g., FIG. 8) For example, the user can enter in a certification number 810, and search for a particular gemstone. Alternatively, the user can select from a certification body 815 (e.g., Gemological Institute of America, American Gem Society, International Gemological Institute Hoge Raad voor Diamant, and European Gemological Laboratory).

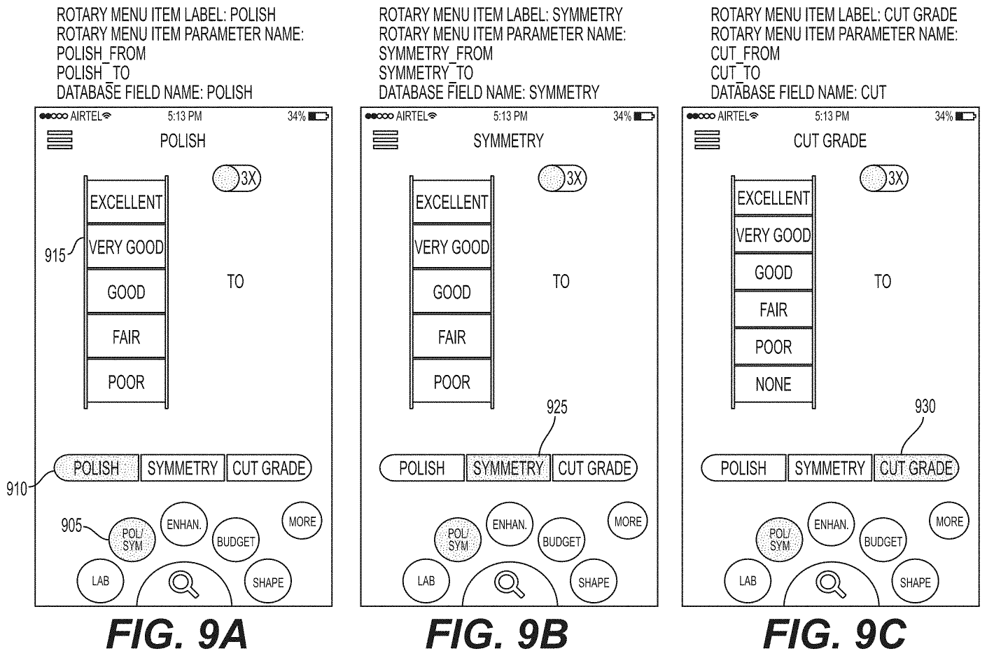

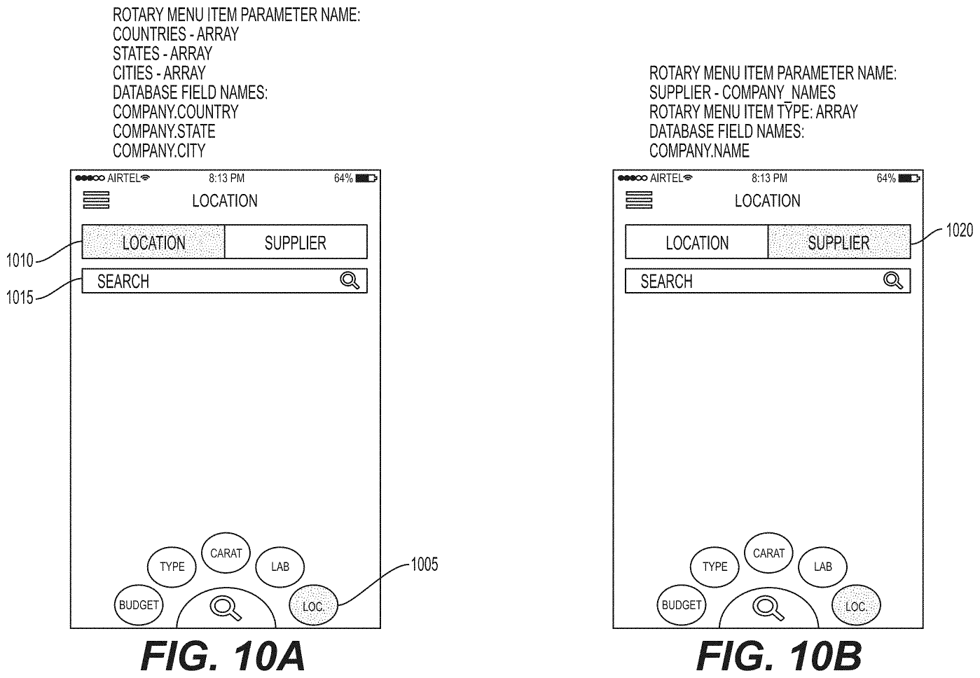

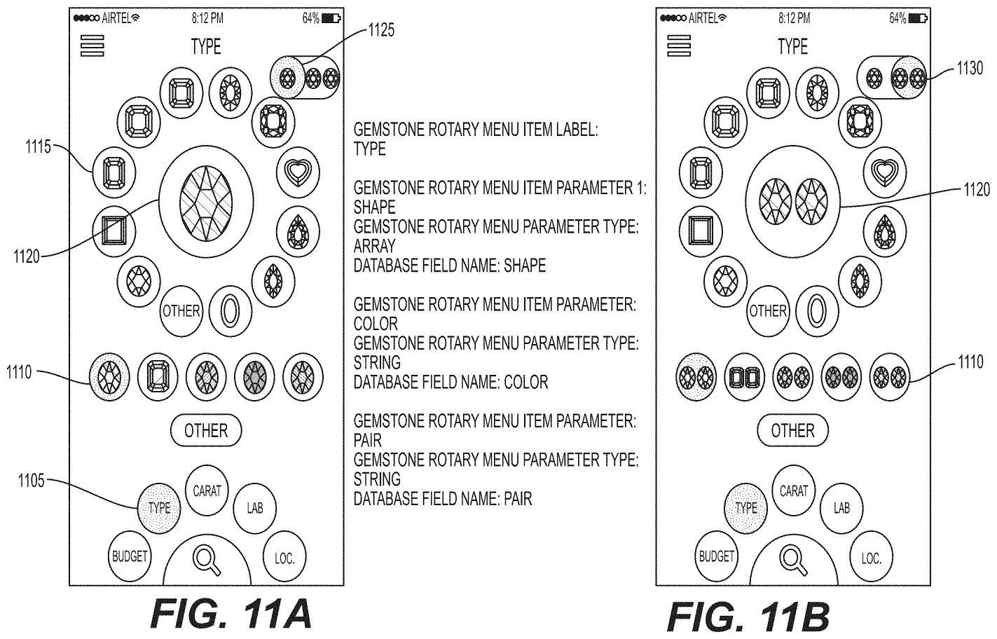

As shown in FIGS. 9A-9C, the user can select the pol/sym attribute 910, which can facilitate the selection of polish 910, symmetry 925 and cut grade 930, each of which can range from poor to excellent. The user can select the loc attribute 1005, which can facilitate the selection of a location 1010 of the gemstone (e.g., through search 1015) or for the selection of a particular supplier 1020 (e.g., also through search 1015). (See, e.g., FIGS. 10A and 10B). Further, the user can select the type attribute 1105, which can facilitate the selection of the type of gemstone. (See, e.g., FIGS. 11A and 11B). For example, the user can select from different types of gemstone in selection area 1110, and can select different shapes 1115. The changed type of gemstone can be illustrated in area 1120. Exemplary gemstones from which the user can select can include, but are not limited to, diamond, jade, amethyst, azurite, bismuth, onyx, opal, sapphire, topaz, quartz, emerald, garnet, obsidian, ruby, spinel, tanzanite, turquoise and zircon.

In order to select the gemstone type, the user can tap the screen at the location of the gemstone type. Alternatively, or in addition, the user can slide their finger in a circular fashion around the type selection area to change the selected type. The user can also select from a single gemstone 1125, or from multiple gemstones 1130.

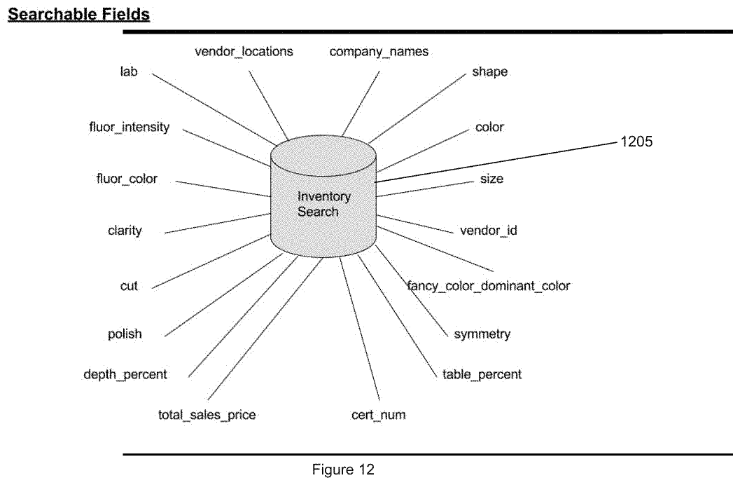

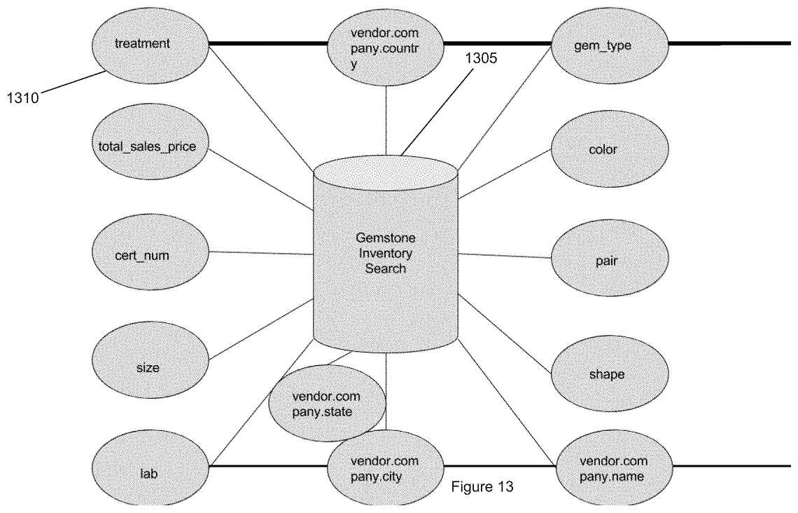

FIGS. 12 and 13 show exemplary schematic diagrams of an exemplary inventory search database according to an exemplary embodiment of the present disclosure. For example, as shown therein, inventory search 1205 can include information pertaining to the various attributes 1310 of the gemstone (e.g., lab, clarity, color, cut, polish etc.).

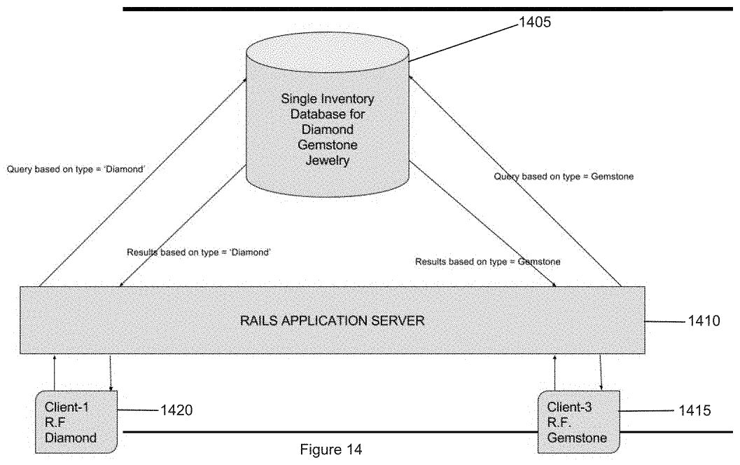

FIG. 14 shows an exemplary schematic diagram of an exemplary rails application server according to an exemplary embodiment of the present disclosure. For example, as shown in FIG. 14, the RAILS application server 1410 can facilitate the searching and filtering of the single inventory database 1405 by client 1415 and client 1420.

As illustrated and described above, the exemplary system, method and computer-accessible medium, according to an exemplary embodiment of the present disclosure can facilitate the filtering and selection of a gemstone based on a plurality of attributes pertaining to the gemstone. The exemplary system, method and computer-accessible medium, according to an exemplary embodiment of the present disclosure, is easy to use, and solves the problem of previous systems, which can be difficult to operate and filter, and which make it difficult to ultimately find, select and purchase a gemstone. Thus the exemplary system, method and computer-accessible medium, according to an exemplary embodiment of the present disclosure, can increase the sales of the gemstone as the user can more easily filter and locate a desired gemstone.

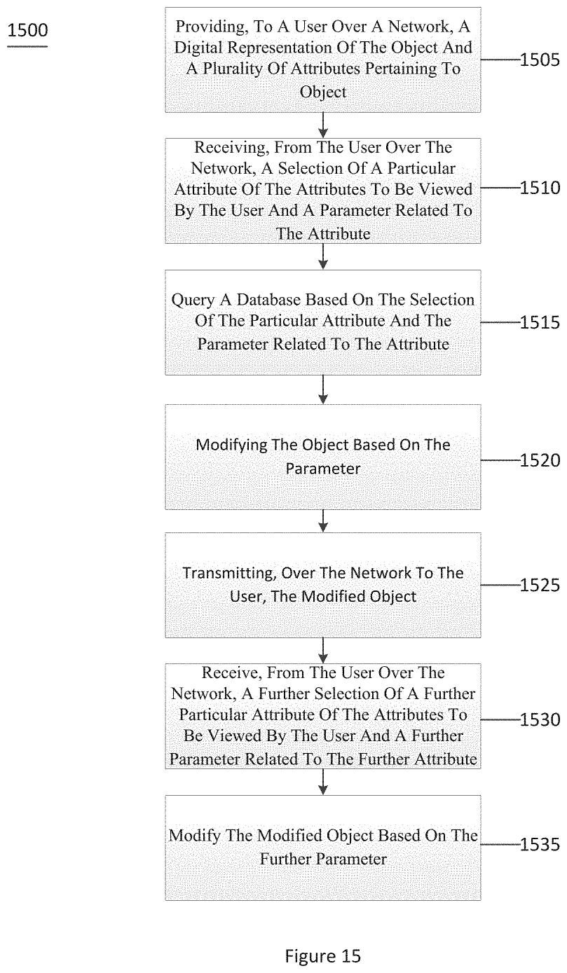

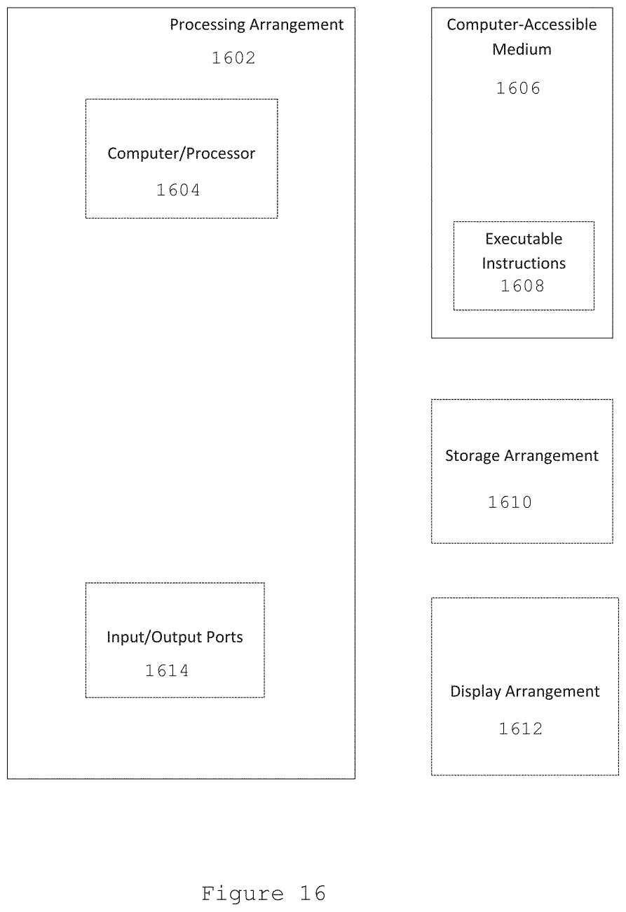

FIG. 15 shows an exemplary flow diagram of an exemplary method 1500 for facilitating a selection of at least one object according to an exemplary embodiment of the present disclosure (e.g., by a computer processor arrangement which can be but not limited to a configuration/system shown in FIG. 16). For exemplary, at procedure 1505, using a network, a user can be provided with a digital representation of an object and a plurality of parameters pertaining to the object. At procedure 1510, using a network, a selection of a particular attribute to be viewed can be received from the user and a parameter related to the attribute. At procedure 1515, a database can be queried based on the selection of the attribute and the parameter related to the attribute. At procedure 1520, the object can be modified based on the parameter. At procedure 1525, the modified object can be transmitted to the user over the network. At procedure 1530, a further selection of a further particular attribute to be viewed by the user, and a further parameter related to the further attribute, can be received from the user over the network. At procedure 1535, the modified object can be modified again based on the further parameter.

FIG. 16 shows a block diagram of an exemplary embodiment of a system according to the present disclosure. For example, exemplary procedures in accordance with the present disclosure described herein can be performed by a processing arrangement and/or a computing arrangement 1602. Such processing/computing arrangement 1602 can be, for example entirely or a part of, or include, but not limited to, a computer/processor 1604 that can include, for example one or more microprocessors, and use instructions stored on a computer-accessible medium (e.g., RAM, ROM, hard drive, or other storage device).

As shown in FIG. 16, for example a computer-accessible medium 1606 (e.g., as described herein above, a storage device such as a hard disk, floppy disk, memory stick, CD-ROM, RAM, ROM, etc., or a collection thereof) can be provided (e.g., in communication with the processing arrangement 1602). The computer-accessible medium 1606 can contain executable instructions 1608 thereon. In addition or alternatively, a storage arrangement 1610 can be provided separately from the computer-accessible medium 1606, which can provide the instructions to the processing arrangement 1602 so as to configure the processing arrangement to execute certain exemplary procedures, processes and methods, as described herein above, for example.

Further, the exemplary processing arrangement 1602 can be provided with or include an input/output arrangement 1614, which can include, for example a wired network, a wireless network, the internet, an intranet, a data collection probe, a sensor, etc. As shown in FIG. 16, the exemplary processing arrangement 1602 can be in communication with an exemplary display arrangement 1612, which, according to certain exemplary embodiments of the present disclosure, can be a touch-screen configured for inputting information to the processing arrangement in addition to outputting information from the processing arrangement, for example. Further, the exemplary display 1612 and/or a storage arrangement 1610 can be used to display and/or store data in a user-accessible format and/or user-readable format.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

1. A non-transitory computer-accessible medium having stored thereon computer-executable instructions for facilitating a selection of at least one object, wherein, when a computer arrangement executes the instructions, the computer arrangement is configured to perform procedures comprising:
providing, to at least one user over a network, a digital representation of the at least one object and a plurality of attributes pertaining to the at least one object;
receiving, from the at least one user over the network, a selection of a particular attribute of the attributes to be viewed by the at least one user and at least one parameter related to the attribute;
modifying at least one visual aspect of the at least one object based on the at least one parameter; and
transmitting, over the network to the at least one user, the modified visual aspect of at least one object.

2. The computer-accessible medium of claim 1, wherein the at least one object is at least one gemstone or at least one jewelry.

3. The computer-accessible medium of claim 2, wherein the at least one attribute includes at least one of (i) a color of the at least one gemstone, (ii) a clarity of the at least one gemstone, (iii) a cut of the at least one gemstone, (iv) a polish of the at least one gemstone or (v) a depth percent of the at least one gemstone.

4. The computer-accessible medium of claim 2, wherein the at least one attribute includes at least one of (i) a budget, (ii) a certifying body, (iii) a shape of the at least one gemstone, (iv) a size of the at least one gemstone, (v) a symmetry of the at least one gemstone, or (vi) a table percent of the at least one gemstone.

5. The computer-accessible medium of claim 2, wherein the at least one gemstone includes a diamond.

6. The computer-accessible medium of claim 1, wherein the selection of the particular attribute and the at least one parameter related to the particular attribute are received from a mobile device.

7. The computer-accessible medium of claim 1, wherein the object and the at least one attribute are stored in at least one database.

8. The computer-accessible medium of claim 7, wherein the computer arrangement is further configured to query the at least one database based on the selection of the particular attribute and the at least one parameter related to the attribute.

9. The computer-accessible medium of claim 1, wherein the computer arrangement is further configured to:
receive, from the at least one user over the network, a further selection of a further particular attribute of the attributes to be viewed by the at least one user and at least one further parameter related to the further attribute; and
modify the at least one modified object based on the at least one further parameter.

10. The computer-accessible medium of claim 1, wherein the selection is based on a rotation of a digital wheel by the at least one user.

11. The computer-accessible medium of claim 1, wherein the selection of the particular attribute and the at least one parameter related to the particular attribute are received from a web-based application.

12. The computer-accessible medium of claim 1, wherein the computer arrangement is further configured to modify the parameter based on an input from the at least one user.

13. The computer-accessible medium of claim 1, wherein the computer arrangement is configured to modify the parameter using at least one digital slider.

14. The computer-accessible medium of claim 1, wherein the computer arrangement is configured to modify the parameter based on an upper limit of the parameter and a lower limit of the parameter.

15. A method for facilitating a selection of at least one object, comprising:
providing, to at least one user over a network, a digital representation of the at least one object and a plurality of attributes pertaining to the at least one object;
receiving, from the at least one user over the network, a selection of a particular attribute of the attributes to be viewed by the at least one user and at least one parameter related to the attribute;
modifying at least one visual aspect of the at least one object based on the at least one parameter; and
using a specifically configured computer hardware arrangement, transmitting, over the network to the at least one user, the modified visual aspect of at least one object.

16. The method of claim 15, wherein the at least one object is at least one gemstone or at least one jewelry.

17-23. (canceled)

24. The method of claim 15, wherein the selection is based on a rotation of a digital wheel by the at least one user.

25. The method of claim 15, wherein the selection of the particular attribute and the at least one parameter related to the particular attribute are received from a web-based application.

26. (canceled)

27. The method of claim 15, further comprising modifying the parameter using at least one digital slider.

28. The method of claim 15, further comprising modifying the parameter based on an upper limit of the parameter and a lower limit of the parameter.

29. A system for facilitating a selection of at least one object, comprising:
a specifically configured computer hardware arrangement configured to:
provide, to at least one user over a network, a digital representation of the at least one object and a plurality of attributes pertaining to the at least one object;
receive, from the at least one user over the network, a selection of a particular attribute of the attributes to be viewed by the at least one user and at least one parameter related to the attribute;
modify at least one visual aspect of the at least one object based on the at least one parameter; and
transmit, over the network to the at least one user, the modified visual aspect of at least one object.

30. The system of claim 29, wherein the at least one object is at least one gemstone or at least one jewelry.

31-42. (canceled)
